(19) United States
(12) Patent Application Publication
(10) Pub. No.: US 2019/0236551 A1
(43) Pub. Date: Aug. 1, 2019

(54) PROVISION OF INFORMATION REGARDING THE IMPACT OF EXTENDING A MEETING

(71) Applicant: Avaya Inc., Basking Ridge, NJ (US)

(72) Inventors: Hemang Shah, Morgan Hill, CA (US); Michael Krack, Los Altos, CA (US); Lee Shero, McKinney, TX (US); Jeffrey Wong, San Jose, CA (US); Jai Pugalia, San Jose, CA (US)

(21) Appl. No.: 15/885,562

(22) Filed: Jan. 31, 2018

(51) Int. Cl. G06Q 10/10; G06Q 10/06

(52) U.S. Cl. CPC G06Q 10/1053; G06Q 10/063116

(57) ABSTRACT

The technology disclosed herein enables a conferencing client operated by a meeting organizer to present the meeting organizer with information about the impact of extending a meeting past its scheduled end time. In a particular embodiment, a method provides, in a conferencing server, establishing a conferencing session for the meeting with an organizer conferencing client operated by the organizer. During the meeting, the method provides identifying participants in the meeting, accessing a schedule for each of the participants and determining an availability for each of the participants past the scheduled end time of the meeting from the respective schedules. The method further provides determining the impact based on the availability for each of the participants.

### TECHNICAL BACKGROUND

Scheduled meetings often require more time to complete than originally scheduled. Ideally, the meeting can simply be completed by extending beyond the scheduled end time. However, participants in the meeting may have other obligations following the scheduled end time or a meeting room in which at least some of the participants are located may be reserved for other purposes after the scheduled end time. As such, there is no guarantee that the meeting can simply be extended past the originally scheduled end time. Moreover, in order for a meeting organizer to find out whether it is even possible to extend the meeting, the organizer must interrupt the meeting to discuss the potential extension with the meeting participants. That interruption is disruptive to the flow of the meeting and can be time consuming. Furthermore, some participants may not immediately know their availability to extend the meeting when asked, thereby adding to uncertainty about extending the meeting.

### SUMMARY

The technology disclosed herein enables a conferencing client operated by a meeting organizer to present the meeting organizer with information about the impact of extending a meeting past its scheduled end time. In a particular embodiment, a method provides, in a conferencing server, establishing a conferencing session for the meeting with an organizer conferencing client operated by the organizer. During the meeting, the method provides identifying participants in the meeting, accessing a schedule for each of the participants and determining an availability for each of the participants past the scheduled end time of the meeting from the respective schedules. The method further provides determining the impact based on the availability for each of the participants.

In some embodiments, the method provides presenting the impact to the organizer via the organizer conferencing client.

In some embodiments, identifying the participants comprises identifying one or more users associated with one or more conferencing clients also connected to the conferencing session.

In some embodiments, determining the availability for each of the participants comprises determining whether the participants have availability at each of a plurality of time thresholds beyond the scheduled end time and determining whether a location of one or more of the participants is available at each of the plurality of time thresholds beyond the scheduled end time. In those embodiments, determining the impact may comprise determining a percentage of the participants that have availability at each of the plurality of time thresholds, wherein the impact includes the percentages.

In some embodiments, determining the impact comprises, when the availability for one participant of the participants indicates that participant has another meeting scheduled within a threshold amount of time after the scheduled end time, determining a likelihood that the one participant will leave for the other meeting, wherein the impact includes the likelihood. In those embodiments, a basis for determining the likelihood that the one participant will leave for the other meeting may include one or more of historical meeting attendance information for the one participant and importance of the one participant to the other meeting.

In some embodiments, upon the organizer indicating, via the organizer conferencing client, that the meeting will extend past the scheduled end time, the method provides transferring a notification that the meeting will extend past the scheduled end time to each of one or more of the participants. In those embodiments, the method may further include receiving one or more responses to the notification from respective ones of the one or more of the participants indicating whether the respective ones of the one or more of the participants will remain on the meeting.

In some embodiments, the method provides, upon the organizer indicating, via the organizer conferencing client, that the meeting will extend past the scheduled end time, transferring a notification to one or more organizers of one or more meetings that one or more of the participants will be late to due to the meeting extending past the scheduled end time.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to establish a conferencing session for the meeting with an organizer conferencing client operated by the organizer. During the meeting, the program instructions direct the processing system to identify participants in the meeting, access a schedule for each of the participants, and determine an availability for each of the participants past the scheduled end time of the meeting from the respective schedules. The program instructions further direct the processing system to determine the impact based on the availability for each of the participants.

### BRIEF DESCRIPTION OF THE DRAWINGS

FIG. 1 illustrates an implementation for providing an organizer of a meeting with information about impact of extending the meeting.

FIG. 2 illustrates a scenario for the implementation to provide an organizer of a meeting with information about impact of extending the meeting.

FIG. 3 illustrates another implementation for providing an organizer of a meeting with information about impact of extending the meeting.

FIG. 4 illustrates a scenario for the other implementation to provide an organizer of a meeting with information about impact of extending the meeting.

FIG. 5 illustrates another scenario for the other implementation to provide an organizer of a meeting with information about impact of extending the meeting.

FIG. 6 illustrates schedule information for the other implementation to provide an organizer of a meeting with information about impact of extending the meeting.

FIG. 7 illustrates a display for the other implementation to provide an organizer of a meeting with information about impact of extending the meeting.

FIG. 8 illustrates another display for the other implementation to provide an organizer of a meeting with information about impact of extending the meeting.

FIG. 9 illustrates a computing architecture for providing an organizer of a meeting with information about impact of extending the meeting.

### DETAILED DESCRIPTION

A large percentage of modern organizations use calendar services to host the schedules of members of the organization (e.g., employees, contractors, etc.). This typically allows for the members to access and manipulate their schedules from any client (e.g., application) configured to access the calendar service. Meetings and appointments can be scheduled, moved, canceled, etc., using the client. As such, the schedules for various members of the organization may be accessed using this centralized calendar service. The examples provided below leverage this capability of a calendar service to determine the schedules of participants in a meeting, and possibly the schedule of a location where the meeting is being held, to determine an impact of extending a meeting should such an extension be desired by a meeting organizer. Information about the impact is provided to the meeting organizer and the meeting organizer can then make a more informed decision about whether to extend the meeting or take alternative action, such as rescheduling the meeting for another time.

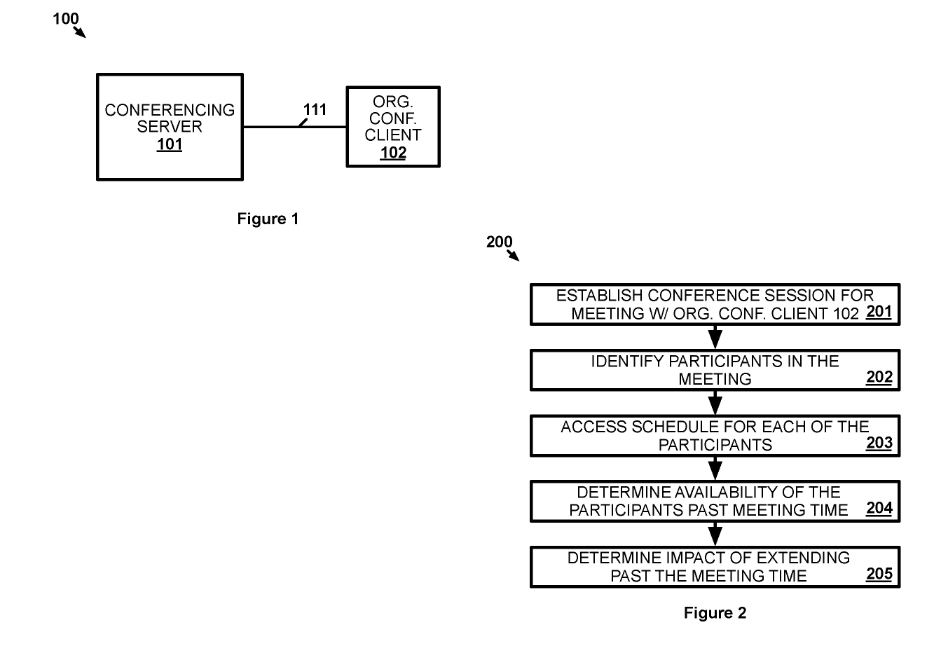

FIG. 1 illustrates implementation 100 for providing an organizer of a meeting with information about impact of extending the meeting. Implementation 100 includes conferencing server 101 and organizer conferencing client 102. Conferencing server 101 and organizer conferencing client 102 communicate over communication link 111. Communication link 111 comprises one or more wired or wireless communication links and may also include intervening systems, networks, and/or devices.

In operation, conferencing server 101 schedules and facilitates meetings by connecting to one or more conferencing clients, such as organizer conferencing client 102. Organizer conferencing client 102 comprises a computing device that executes client software for directing the computing device to connect to conferencing server 101 for participating in meetings scheduled by conferencing server 101. Organizer conferencing client 102 may be a laptop, phone, tablet, workstation, conference room system, or some other type of computing device. Conferencing server 101 may maintain calendar service information as well or may interact with a separate calendar service system. When a meeting to be facilitated by conferencing server 101 is scheduled by a meeting organizer, the meeting will be placed in the schedules of the participants in the meeting to block off the requested meeting time period. For example, conferencing server 101 or the calendar service system may send a meeting invite that informs participants designated by the meeting organizer of the meeting. In some cases, the participants may be giving the opportunity to accept the meeting invite before it is placed into their respective schedules. Within each participants schedule, the meeting calendar item may include information about connecting a conferencing client to conferencing server 101 for the meeting, information for dialing into conferencing server 101 for the meeting, information about the meeting topic(s), or some other type of information pertinent to the meeting. Once the meeting begins, conferencing server 101 communicates with at least organizer conferencing client 102 to provide the organizer of the meeting, who operates organizer conferencing client 102, with information about the impact of the meeting going long. Likewise, conferencing server 101 may handle the transfer of user communication media (e.g., audio, video, and/or other type of media) between remotely connected conferencing clients operated by one or more participants in the meeting.

FIG. 2 illustrates scenario 200 for implementation 100 to provide an organizer of a meeting with information about impact of extending the meeting. In scenario 200, conferencing server 101 establishes a conferencing session for the meeting with organizer conferencing client 102 operated by the meeting's organizer (201). If all the meeting participants are co-located with the meeting organizer, then only organizer conferencing client 102 may be connected to conferencing server 101 once the conferencing session is established, although one or more of the participants may connect to conferencing server 101 for other reasons during the conference session (e.g., to browse media, such as presentation slides, during the meeting).

During the meeting, conferencing server 101 identifies participants in the meeting (202). The participants may be identified based on which participants logged into the meeting, or otherwise identified themselves, through their respective conferencing clients, through a conferencing client other than their own, such as through organizer conferencing client 102 or a conferencing room system. Alternatively, the organizer may identify the participants in the meeting, conferencing server 101 may recognize participants from the user communications of the conferencing session (e.g., using voice or image recognition to identify participants), conferencing server 101 may assume that whoever was invited to participate, or accepted the invite to participate, is in the meeting, or may identify the meeting participants in some other manner—including combinations thereof. In some cases, only those participants with schedules that are accessible by conferencing server 101 may be identified.

To provide impact information, conferencing server 101 accesses a schedule for each of the participants (203). The schedule of each participant may be maintained locally at conferencing server 101 or conferencing server 101 may access a separate calendar service system to obtain schedule information for each participant. In some cases, multiple calendar services may be used by the participants and conferencing server 101 may therefore need to access multiple calendar service systems to obtain schedule information. Conferencing server 101 may further access a schedule for one or more meeting location where participants, including the organizer, are located.

Conferencing server 101 uses information from the participant's schedules to determine an availability for each of the participants past the scheduled end time of the meeting from the participants' respective schedules (204). The schedule information at least indicates whether a participant has another obligation (e.g., another meeting, an appointment, etc.) scheduled immediately following the meeting but may further look at a participant's availability at times other than that immediately following the meeting to better indicate how long a participant may be able to attend an extended meeting (e.g., a participant may have another obligation 20 minutes after the meeting's scheduled end time). Essentially, the schedule information is used by conferencing server 301 to determine a likelihood that a participant is able to remain in the meeting. Furthermore, in addition to considering the timing of participants' other obligations, conferencing server 101 may consider other factors, such as the importance of the other obligation, either in total or relative to the current meeting, or a participant's value to that other obligation, either in total or relative to their importance to the current meeting. In some cases, the meeting organizer may indicate the importance of each respective participant at the time the meeting is scheduled or at some other time. Alternatively, conferencing server 101 may determine a participant's importance automatically. For example, conferencing server 101 may use a topic of the meeting, as indicated by the organizer or otherwise determined, along with the participant's role in the organization to determine whether the participant is important for the topic of the meeting. Conferencing server 101 may rate a person's importance on a scale (e.g., low, medium, high). If a participant is determined to be more important in another obligation that would overlap in time if the meeting is extended, then conferencing server 101 may determine that the participant is not available, or is likely not going to be available, past the time that other obligation is set to begin. In some examples, conferencing server 101 may also poll one or more of the participants to ask them whether they are available, and possibly for how long they are available, should the meeting organizer want to extend the meeting. If a participant is using a client device, then conferencing server 101 may poll the participant using that device. Otherwise, conferencing server 101 may use some other form of communication, such as sending the participant a text message or email.

Once the availability of the participants is determined, conferencing server 101 determines the impact based on the availability for each of the participants (205). The impact represents information pertaining to whether participants will likely be able to stay in the meeting past the meeting's scheduled end time. The impact may be greater if more participants are likely not able to stay in the meeting. Likewise, the impact may be greater if more important participants are not able to stay in the meeting. In some cases, conferencing server 101 may represent the impact as a metric, such as a scale of 1-10 with 10 being the greatest impact, while in other examples conferencing server 101 may include relevant information that a meeting organizer would find useful in making their own impact determination. Various thresholds may be used by conferencing server 101 to determine an impact metric or to determine what information may be relevant to the meeting organizer. For example, if all participants are considered of equal importance a percentage threshold may be used that relies on a certain percentage of the participants remaining to indicate a lower impact. In another example, if only a few participants are deemed to be important, the impact may still be low if other participants are not available as long as those few participants remain. Thus, weighing of factors, such as a participant's importance, against other factors, such as the percentage of participants that are available to remain in the meeting, may also be used by conferencing server 101 to determine the impact of extending the meeting. In further examples, conferencing server 101 may consider whether other meetings are scheduled in one or more of the meeting locations (e.g., conference room) in which participants are located. In those examples, conferencing server 101 may consider the importance of participants at a particular meeting location and whether those participants can join the meeting elsewhere when determining the impact severity of another meeting displacing the participants in that location.

Once the impact has been determined, conferencing server 101 may present the impact to the meeting organizer by sending impact information to organizer conferencing client 102, which can display, or otherwise indicate, a representation of the impact to the meeting organizer. The meeting organizer can then make a judgment call about whether to extend the meeting based on that presentation. For example, if the presented impact information indicates to the organizer that extending the meeting would have too great of an impact (either on other obligations of the participants or on the meeting itself from participant departures), then the organizer may choose not to extend the meeting. In some examples, if a participant chooses to stay in the meeting instead of going to another obligation, conferencing server 101 may send a notification (e.g., calendar event update, email, text, etc.) to an organizer of that other obligation to inform them that the participant will be staying longer in the current meeting.

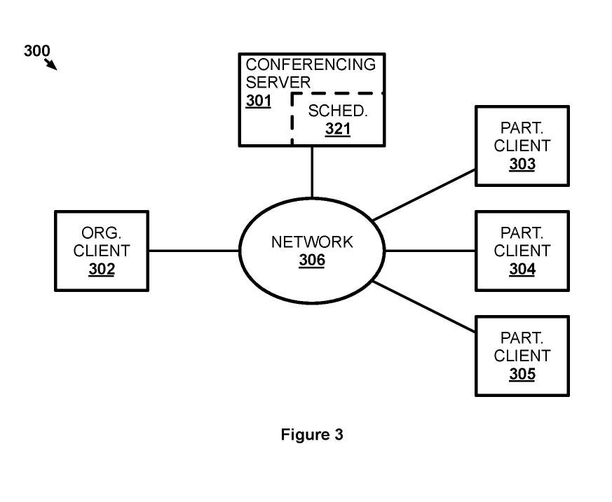

FIG. 3 illustrates implementation 300 for providing an organizer of a meeting with information about impact of extending the meeting. Implementation 300 includes conferencing server 301, organizer conferencing client 302, participant conferencing client 303, participant conferencing client 304, participant conferencing client 305, and communication network 306. In this example, participant conferencing client 303, participant conferencing client 304, and participant conferencing client 305, along with their respective operating participants, are located remote to organizer conferencing client 302 and its operator, the meeting organizer (also considered a participant). In other examples, one or more of participant conferencing client 303, participant conferencing client 304, and participant conferencing client 305 may be co-located with organizer conferencing client 302. For simplicity, organizer conferencing client 302, participant conferencing client 303, participant conferencing client 304, and participant conferencing client 305 are each operated by a single participant.

In operation, conferencing server 301 facilitates a conferencing session over communication network 306 for a meeting scheduled between participants operating organizer conferencing client 302, participant conferencing client 303, participant conferencing client 304, and participant conferencing client 305. The conferencing session may be an audio conference or a videoconference between the participants and may include additional media, such as presentation slides, audio, video, animations, or some other type of media—including combinations thereof. In the scenarios below, conferencing server 101 further maintains schedules for the participants by acting as a calendar service, although may rely on a separate calendar service to maintain the schedules in other examples.

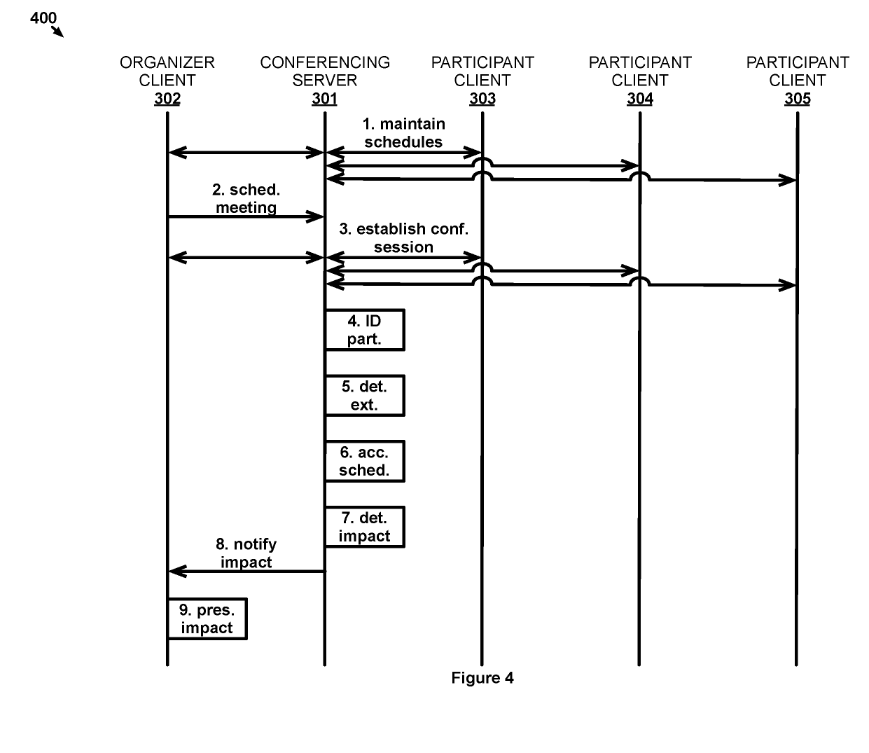

FIG. 4 illustrates scenario 400 for implementation 300 to provide an organizer of a meeting with information about impact of extending the meeting. In scenario 400, conferencing server 301 maintains schedules at step 1 for participants of each of organizer conferencing client 302, participant conferencing client 303, participant conferencing client 304, and participant conferencing client 305. While scenario 400 shows the schedules being maintained via interaction with organizer conferencing client 302, participant conferencing client 303, participant conferencing client 304, and participant conferencing client 305, the participants may access their respective schedules using other client devices that also interact with conferencing server 301. While shown as a separate step, step 2 is included in the schedule maintenance whereby the conference organizer schedules a meeting having a start time and an end time. The meeting in this case includes information needed for participant conferencing client 303, participant conferencing client 304, and participant conferencing client 305 to join organizer conferencing client 302 on a conferencing session facilitated for the meeting by conferencing server 301. The organizer may further indicate one or more topics for discussion during the meeting, documents relevant to the meeting, a meeting agenda, or some other type of information related to the meeting—including combinations thereof.

At the start time, a conference session for the scheduled meeting is established at step 3 by conferencing server 301 between organizer conferencing client 302, participant conferencing client 303, participant conferencing client 304, and participant conferencing client 305. It should be understood that each client need not be connected to the meeting at exactly the same time, as it is common for conference session participants to join a conference session in a staggered manner. After the conference session is started, conferencing server 301 identifies the participants in the meeting at step 4. The participants identified in this case are the participants who are respectively operating participant conferencing client 303, participant conferencing client 304, and participant conferencing client 305. In other examples, conferencing server 301 may further identify the organizer as being one of the participants for inclusion in the impact determination discussed below.

In this example, rather than automatically determining the impact of extending the meeting past its scheduled end time, conferencing server 301 determines that the meeting may be extended at step 5. For instance, the organizer may instruct organizer conferencing client 302 to notify conferencing server 301 that conferencing server 301 should provide the organizer with information regarding the potential impact of the meeting going long. Alternatively, conferencing server 301 may determine that the pace of the meeting indicates that the meeting will likely go long. For example, conferencing server 301 may determine that the amount of time needed to cover the remaining slides in a presentation (e.g., based on the amount of time used to cover previous slides) is greater than the amount of time until the scheduled end time for the meeting. In some cases, the identification of the participants from step 4 may wait until after it is determined that conferencing server 301 should determine the impact at step 5.

Conferencing server 301 accesses the schedules of each of the identified participants at step 6 to determine the likelihood that each respective participant will be able to remain on the conference session beyond the originally scheduled end time. The likelihood may include an amount of time the participant is likely to be able to remain on the conference session. The likelihood may depend on a time when each participant's next obligation is scheduled, if any exists, and a likelihood that the participant will need to leave the call for that obligation. The likelihood that a participant will leave for a subsequent obligation may depend on how that important that obligation is to the participant or how important the participant is to the obligation. Likewise, conferencing server 301 may be able to consider when the participant is actually needed for the subsequent obligation. For example, conferencing server 301 may know from information regarding the subsequent obligation (e.g., a meeting agenda) that the participant will not be needed for the obligation for a half hour after the obligation is scheduled to start. Additionally, when determining the likelihood that a participant will stay on the conference session, conferencing server 301 may consider a participant's past behavior regarding similar subsequent obligations. That is, if the participant historically does not usually participate in the subsequent obligation, then the likelihood of the participant staying on the conference session is greater. Thresholds may also be used by conferencing server 301 when analyzing a participant's historical behavior. For example, conferencing server 301 may use a threshold percentage of historical attendance for a particular meeting, or meeting having similar characteristics (e.g., same organizer, many of the same participants, same topics, etc.) to determine whether the participant is likely to leave the current meeting (e.g., if the participant attends the meeting at least 80% of the time, then the participant is likely to leave the current meeting to attend that meeting).

Conferencing server 301 then determines impact information at step 7 that will be provided to organizer conferencing client 302 for presentation to the organizer. The impact information may simply include an indication of each participant's likelihood of remaining in the meeting. Alternatively, the impact information may include additional metrics, including information used to determine the likelihood of a participant remaining in the meeting, or may be organized in a manner to make parsing the information easier on the organizer (e.g., separating important participants from non-important participants in the current meeting).

Upon determining the impact information, conferencing server 301 transfers the impact information at step 8 to organizer conferencing client 302 to notify organizer conferencing client 302 of the impact. Organizer conferencing client 302 then presents the impact information to the meeting organizer who can then use the information to determine whether to allow the meeting to extend beyond its scheduled end time. In some examples, the organizer may indicate to organizer conferencing client 302 how they want the impact information to be displayed (e.g., text, graphs, etc.) to best assist the organizer when making the meeting extension decision.

In some cases, the impact information may include information about a meeting location if the meeting is being held in a location that may be reserved for other purposes after the current meeting. In those cases, the impact information may indicate to the organizer whether the meeting room is available for extending the meeting and, if not, may provide suggestions for alternative locations in which the organizer may continue the meeting (e.g., another available conference room).

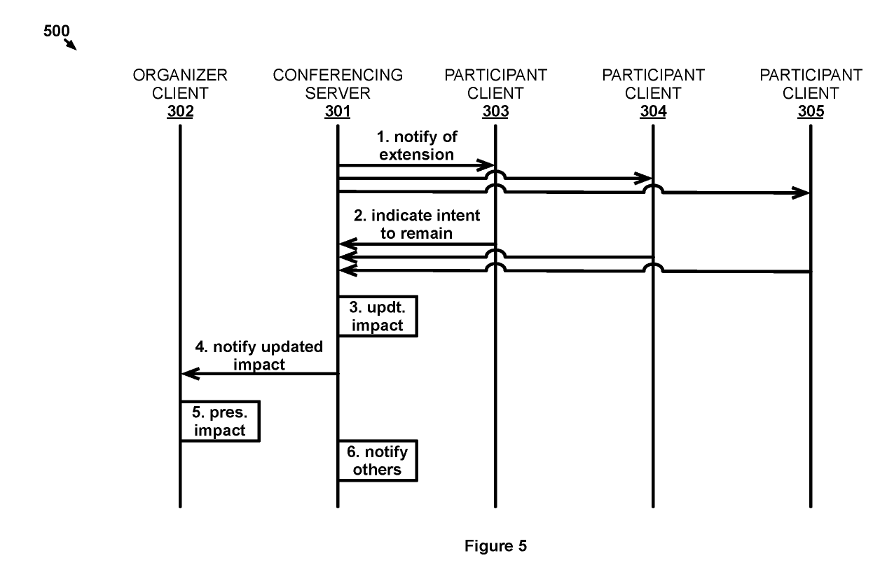

FIG. 5 illustrates scenario 500 for implementation 300 to provide an organizer of a meeting with information about impact of extending the meeting. Scenario 500 may be performed in addition to the steps of scenario 400. In scenario 500, conferencing server 301 sends a notification to each of participant conferencing client 303, participant conferencing client 304, and participant conferencing client 305. The notification indicates that the organizer is considering extending the meeting beyond its scheduled end time. Additionally, the notification acts as a polling mechanism to solicit responses from the participants indicating whether the participants will be able to remain in the meeting if the meeting were to extend beyond the scheduled end time. In some examples, the participants may each be able to also indicate how long past the scheduled end time they are able to stay, if they are able to stay at all.

In response to the notification, each of participant conferencing client 303, participant conferencing client 304, and participant conferencing client 305 transfers a response at step 2 indicating each participants intent to remain in the meeting. The intent having been indicated to participant conferencing client 303, participant conferencing client 304, and participant conferencing client 305 by their respective participants. Of course, if a participant does not intend to stay or otherwise does not respond to the notification, then no response will be received from that participant. Upon receiving responses, conferencing server 301 updates the impact information previously determined in scenario 500 at step 3. For example, if scenario 400 determined that the participant operating participant conferencing client 305 is available for 10 minutes beyond the meeting end time but the response from participant conferencing client 305 indicates that the participant actually intends to stay for 25 minutes, then the impact information will be updated to indicate 25 minutes instead of 10 minutes.

After updating the impact information, conferencing server 301 transfers the updated impact information at step 4 to organizer conferencing client 302 and organizer conferencing client 302 presents the updated information at step 5 to the meeting organizer. The updated impact information may be presenting in a manner similar to the presentation of the original impact information in scenario 400. The updated impact information may replace the original information or may be presented in addition to the original information. In some examples, the polling performed by conferencing server 301 may be done before the original impact information is even sent to organizer conferencing client 302. As such, transferring separate updated information, as shown in scenario 500, would not be necessary.

Should the meeting organizer decide to extend the meeting, either by notifying conferencing server 301 of their intent to do so via organizer conferencing client 302 or by simply allowing the conferencing session to continue, conferencing server 301 transfers notifications that the meeting has been extended at step 6 to any interested parties outside of the meeting. An interested party may be someone involved in one of the meeting participant's other obligations that will be impacted if the meeting extends. For example, if a participant in the current meeting has a meeting immediately following the current meeting that the participant will be late to or miss entirely, then conferencing server 301 may notify the organizer of that following meeting that the participant's current meeting will affect the participant's ability to join.

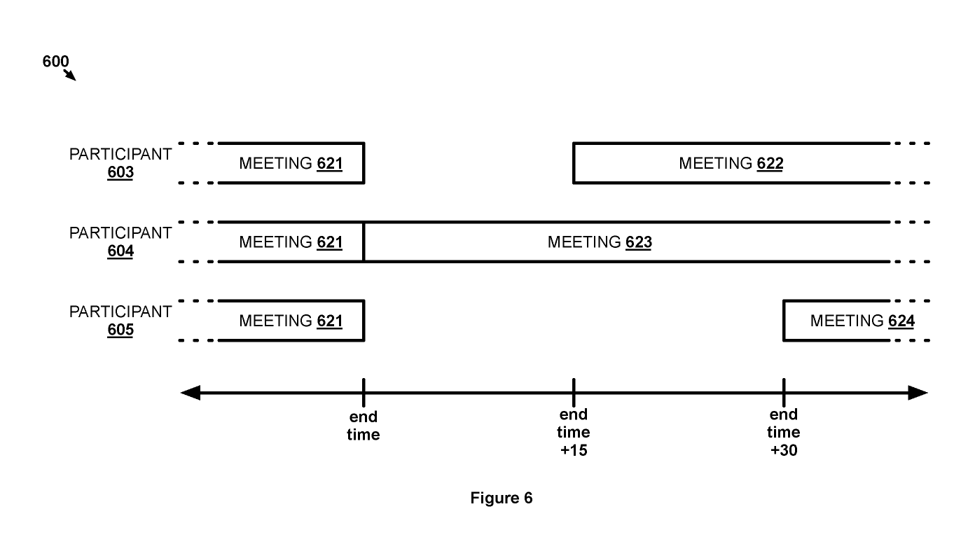

FIG. 6 illustrates schedule information 600 for implementation 300 to provide an organizer of a meeting with information about impact of extending the meeting. Schedule information 600 is a graphical representation of exemplary schedules for participant 603 of participant conferencing client 303, participant 604 of participant conferencing client 304, and participant 605 of participant conferencing client 305. Conferencing server 301 may access and considers schedule information 600 when performing in scenario 400. Schedule information 600 indicates that participant 603, participant 604, and participant 605 are all scheduled to be in the same meeting 621. In this example, meeting 621 is therefore the meeting that may be extended should the organizer determine to do. Schedule information 600 indicates that participant 603 has another meeting 622 to attend that begins 15 minutes past meeting 621's scheduled end time. Schedule information 600 further indicates that participant 604 has a meeting 623 that is scheduled to begin immediately at meeting 621's scheduled end time. Also, schedule information 600 indicates that participant 605 has a meeting 624 that is scheduled to begin 30 minutes past meeting 621's scheduled end time. While not shown, schedule information 600 may further include information about each participant's importance to meeting 621 or their respective importances to meeting 622, meeting 623, and meeting 624.

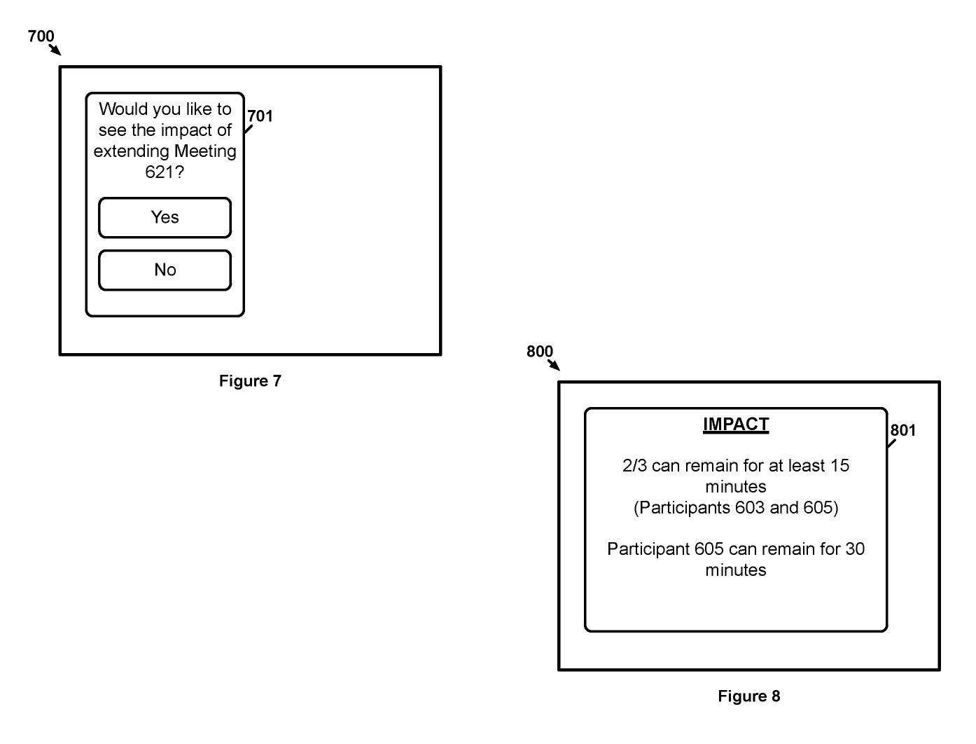

FIG. 7 illustrates display 700 for implementation 300 to provide an organizer of a meeting with information about impact of extending the meeting. Display 700 is an example of what may be displayed by organizer conferencing client 302 during meeting 621 to give the organizer the option of viewing impact information. In particular, display 700 presents selection window 701 giving the organizer the ability to select “yes” or “no” in answer to the question “would you like to see the impact of extending Meeting 621?” selection window 701 may be a window displayed over content for the meeting (e.g., participant video streams, presentation slides, etc.). In some examples, organizer conferencing client 302 may present selection window 701 when meeting 621 is within a threshold amount of time before its scheduled end time. In other examples, selection window 701 may be available for presentation at any time and may be accessed via a menu of organizer conferencing client 302 user interface. It should be understood that selection window 701 is merely one example of how the organizer may be presented with the option to view impact information. Other manners of providing the organizer with the option may be used instead or, in some cases, the organizer may be automatically provided with impact information.

FIG. 8 illustrates display 800 for implementation 300 to provide an organizer of a meeting with information about impact of extending the meeting. Display 800 comprises an example of what may be presented to the organizer by organizer conferencing client 302 after selecting the “yes” option. In this example, display 800 presents impact window 801, which provides impact information of extending meeting 621 in a text format. Specifically, impact window 801 indicates that 2/3 of the participants in meeting 621 can, or are likely to, remain in the meeting for 15 minutes and that only 1 participant can, or are likely to, remain for 30 minutes in accordance with schedule information 600. The impact information in impact window 801 may be impact information sent to organizer conferencing client 302 by conferencing server 301 in accordance with scenario 400 or updated impact information sent to organizer conferencing client 302 by conferencing server 301 in accordance with scenario 500.

It should be understood that impact window 801 is merely an example of how impact information may be presented to the organizer of meeting 621. In other examples, the impact information may be presented in some other manner, such as using graphs or a combination of graphs and text. For instance, participant 603, participant 604, and participant 605 may by listed in impact window 801 and highlighted, or otherwise color coded, with a color representing how long each respective participant can stay. Likewise, the impact information may include more or less information that what is shown in impact window 801 and may depend on what is used by conferencing server 301 to determine the impact information (e.g., whether a participant's importance to meeting 621 or other obligation is considered).

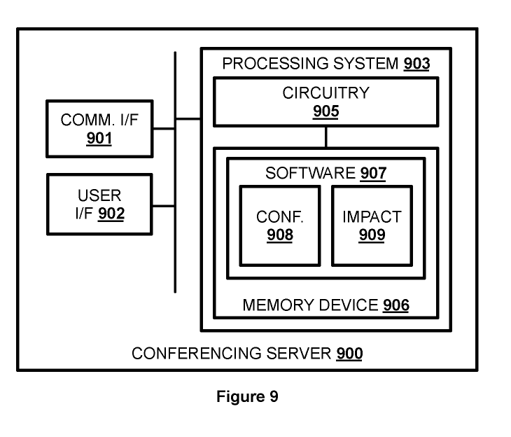

FIG. 9 illustrates conferencing server 900 for providing an organizer of a meeting with information about impact of extending the meeting. Conferencing server 900 is an example computing architecture for conferencing server 101, although server 101 may use alternative configurations. A similar architecture may also be used for an organizer/participant conferencing client, although alternative configurations may also be used. Conferencing server 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a storage medium, such as a disk drive, flash drive, data storage circuitry, or some other memory apparatus. In no examples would memory device 906 be considered a propagated signal. Operating software 907 comprises computer programs, firmware, or some other form of machine-readable processing instructions. Operating software 907 includes conferencing module 908 and impact determination module 909. Operating software 907 may further include an operating system, utilities, drivers, network interfaces, applications, or some other type of software. When executed by processing circuitry 905, operating software 907 directs processing system 903 to operate conferencing server 900 as described herein.

In particular, conferencing module 908 directs processing system 903 to establish a conferencing session for the meeting with an organizer conferencing client operated by the organizer. During the meeting, impact determination module 909 directs processing system 903 to identify participants in the meeting, access a schedule for each of the participants, and determine an availability for each of the participants past the scheduled end time of the meeting from the respective schedules. Impact determination module 909 further directs processing system 903 to determine the impact based on the availability for each of the participants.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for providing an organizer of a meeting with information about impact of the meeting extending past a scheduled end time, the method comprising:
in a conferencing server, establishing a conferencing session for the meeting with an organizer conferencing client operated by the organizer;
during the meeting, identifying participants in the meeting;
accessing a schedule for each of the participants;
determining an availability for each of the participants past the scheduled end time of the meeting from the respective schedules; and
determining the impact based on the availability for each of the participants.

2. The method of claim 1, further comprising:
presenting the impact to the organizer via the organizer conferencing client.

3. The method of claim 1, wherein identifying the participants comprises:
identifying one or more users associated with one or more conferencing clients also connected to the conferencing session.

4. The method of claim 1, wherein determining the availability for each of the participants comprises:
determining whether the participants have availability at each of a plurality of time thresholds beyond the scheduled end time; and
determining whether a location of one or more of the participants is available at each of the plurality of time thresholds beyond the scheduled end time.

5. The method of claim 4, wherein determining the impact comprises:
determining a percentage of the participants that have availability at each of the plurality of time thresholds, wherein the impact includes the percentages.

6. The method of claim 1, wherein determining the impact comprises:
when the availability for one participant of the participants indicates that participant has another meeting scheduled within a threshold amount of time after the scheduled end time, determining a likelihood that the one participant will leave for the other meeting, wherein the impact includes the likelihood.

7. The method of claim 6, wherein a basis for determining the likelihood that the one participant will leave for the other meeting includes one or more of historical meeting attendance information for the one participant and importance of the one participant to the other meeting.

8. The method of claim 1, further comprising:
upon the organizer indicating, via the organizer conferencing client, that the meeting will extend past the scheduled end time, transferring a notification that the meeting will extend past the scheduled end time to each of one or more of the participants.

9. The method of claim 8, further comprising:
receiving one or more responses to the notification from respective ones of the one or more of the participants indicating whether the respective ones of the one or more of the participants will remain on the meeting.

10. The method of claim 1, further comprising:
upon the organizer indicating, via the organizer conferencing client, that the meeting will extend past the scheduled end time, transferring a notification to one or more organizers of one or more meetings that one or more of the participants will be late to due to the meeting extending past the scheduled end time.

11. An apparatus for implementing a conferencing server to provide an organizer of a meeting with information about impact of the meeting extending past a scheduled end time, the apparatus comprising:
one or more computer readable storage media;
a processing system operatively coupled with the one or more computer readable storage media; and
program instructions stored on the one or more computer readable storage media that, when read and executed by the processing system, direct the processing system to:
establish a conferencing session for the meeting with an organizer conferencing client operated by the organizer;
during the meeting, identify participants in the meeting;
access a schedule for each of the participants;
determine an availability for each of the participants past the scheduled end time of the meeting from the respective schedules; and
determine the impact based on the availability for each of the participants.

12. The apparatus of claim 11, wherein the program instructions further direct the processing system to:
present the impact to the organizer via the organizer conferencing client.

13. The apparatus of claim 11, wherein to identify the participants, the program instructions direct the processing system to:
identify one or more users associated with one or more conferencing clients also connected to the conferencing session.

14. The apparatus of claim 11, wherein to determine the availability for each of the participants, the program instructions direct the processing system to:
determine whether the participants have availability at each of a plurality of time thresholds beyond the scheduled end time; and
determine whether a location of one or more of the participants is available at each of the plurality of time thresholds beyond the scheduled end time.

15. The apparatus of claim 14, wherein to determine the impact, the program instructions direct the processing system to:
determine a percentage of the participants that have availability at each of the plurality of time thresholds, wherein the impact includes the percentages.

16. The apparatus of claim 11, wherein to determine the impact, the program instructions direct the processing system to:
when the availability for one participant of the participants indicates that participant has another meeting scheduled within a threshold amount of time after the scheduled end time, determine a likelihood that the one participant will leave for the other meeting, wherein the impact includes the likelihood.

17. The apparatus of claim 16, wherein a basis for determining the likelihood that the one participant will leave for the other meeting includes one or more of historical meeting attendance information for the one participant and importance of the one participant to the other meeting.

18. The apparatus of claim 11, wherein the program instructions further direct the processing system to:
upon the organizer indicating, via the organizer conferencing client, that the meeting will extend past the scheduled end time, transfer a notification that the meeting will extend past the scheduled end time to each of one or more of the participants.

19. The apparatus of claim 18, wherein the program instructions further direct the processing system to:
receive one or more responses to the notification from respective ones of the one or more of the participants indicating whether the respective ones of the one or more of the participants will remain on the meeting.

20. The apparatus of claim 11, wherein the program instructions further direct the processing system to:
upon the organizer indicating, via the organizer conferencing client, that the meeting will extend past the scheduled end time, transfer a notification to one or more organizers of one or more meetings that one or more of the participants will be late to due to the meeting extending past the scheduled end time.
